(19) United States
(12) Patent Application Publication
(10) Pub. No.: US 2005/0179845 A1
(43) Pub. Date: Aug. 18, 2005

(54) Liquid crystal display device and method of manufacturing the same

(76) Inventors: Takakazu Fukuchi, Chiba-shi (JP); Masafumi Hoshino, Chiba-shi (JP); Naohiro Kaneko, Chiba-shi (JP)

Correspondence Address: BRUCE L. ADAMS, ESQ., 50 BROADWAY-31ST FLOOR, NEW YORK, NY, 10004, US

(21) Appl. No.: 11/054,507

(22) Filed: Feb. 9, 2005

(30) Foreign Application Priority Data
Feb. 12, 2004 (JP) 2004-035555
Jan. 25, 2005 (JP) 2005-016751

(51) Int. Cl. G02F 1/1343

(52) U.S. Cl. 349/139

(57) ABSTRACT

The quality of a simple matrix type liquid crystal display device is improved. Thus, in a liquid crystal display device in the present invention, in the case of multi-screen drive with divided signal electrodes, wiring electrodes are formed on a first electrode on which plural signal electrodes are formed, and an insulating layer is formed on portions except connecting regions on the wiring electrodes. Further, the wiring electrodes and the signal electrodes are electrically connected with each other in the connecting regions in which the insulating layer is not formed.

### BACKGROUND OF THE INVENTION

1. Field of the Invention

The present invention relates to a structure of a simple matrix type liquid crystal display device, and more particularly to a structure of a liquid crystal display panel for multi-screen drive in which drive is performed with two or more divided screens.

2. Description of the Related Art

A simple matrix type liquid crystal display device has a structure in which: a liquid crystal layer is held between a row electrode group and a column electrode group; and pixels are provided in matrix. Then, driving methods for the liquid crystal display device include a voltage averaging method, SA method, and MLA method. In any of the driving methods, when the number of rows in a display screen increases, an ON/OFF ratio of an effective value, which affects liquid crystal, becomes small. This results in reduction of contrast and a slower response speed. A solving method for this problem is that: a screen of a liquid crystal display device is divided into two or more screens; and each screen is driven with the divided number of rows, which increases the ON/OFF ratio of an effective value. Thus, a liquid crystal display device with high contrast and high response speed is realized. Known as the structure of the liquid crystal display device in which a display screen is vertically divided into two ore more is a structure in which there are laminated at least two electrodes, a first layer electrode and a second layer electrode electrically separated from the first layer electrode through an insulating film provided to a part of the electrode (for example, refer to JP 5-323338 A).

FIG. 5 shows a structure of a conventional and general semi-transmission type color liquid crystal display device. Description will be made of a method of manufacturing a substrate on the side of color filters. Aluminum is deposited to have a thickness of about 0.15 μm on a transparent substrate 1A by sputtering, and then, the deposited film is subjected to patterning to form a reflecting plate 3. Acrylic resin in which a pigment is dispersed is applied thereon by means of a spinner, and thereafter, patterning is repeatedly performed thereon to form a black matrix 7 and color filters 8R, 8G, and 8B in three primary colors. Transparent acrylic resin is applied thereon with the spinner to form a transparent insulating film 9. Next, ITO or the like is deposited thereon by sputtering so as to be subjected to patterning, thereby forming transparent electrodes 5C for liquid crystal drive. The transparent insulating film 9 has a function of flattening a surface of the black matrix (resin light shielding film) 7 and surfaces of the color filters 8R, 8G, and 8B, and also, has a function of improving adhering property of the transparent electrodes 5C. On a surface of an opposing substrate 1B, opposing electrodes 5D are formed so as to be perpendicular to a pattern of the transparent electrodes 5C formed on the transparent substrate. A space is formed by adhering the transparent substrate 1A to the opposing substrate 1B with a sealing member 20, and liquid crystal 19 is injected into the space.

In a conventional simple matrix type liquid crystal display device, the number of scanning electrodes needed to be set to approximately 200 to 480 in order to maintain image quality. In general, a contrast and a viewing angle become smaller in correspondence with the increase in the number of scanning electrodes. Further, there has been adopted a two-screen drive system in which drive is performed for two divided screens each of which has divided electrodes. In order to perform drive for the divided screen each with more divisions, a structure is needed in which there are laminated at least two electrodes, a first layer electrode and a second layer electrode electrically separated from the first layer electrode through an insulating film provided on a part of the electrode, as described in Patent Document 1. However, in such a structure, the second layer electrode is formed above the first layer electrode, and thus, a large parasitic capacitance is provided between the first layer electrode and the second layer electrode. This is accompanied with the increase in power consumption. Further, the signals, which are respectively applied to the first layer electrode and the second layer electrode, affect each other owing to the parasitic capacitance, which results in distortion of a waveform. Therefore, there has been a problem in that divided screens have different levels of luminance, which leads to reduction in the entire display quality.

### SUMMARY OF THE INVENTION

The present invention has been made in view of the above, and has an object to provide a liquid crystal display device and a method of manufacturing the same to solve the above-mentioned problems in multi division drive. In the liquid crystal display device of the present invention, in order to solve the above problems, both planar separation and a partial two-layer structure are adopted in a structure of a column electrode substrate in the case of multi-screen drive with divided column electrodes. An insulating film, which is made of photo-sensitive resin, is formed on parts of electrodes in a first layer. Thus, electrical insulating property is secured between the first layer electrodes and second layer electrodes. A part of the photo-sensitive insulating film is formed with regions, in which the insulating film is not provided, by patterning. Thereafter, the second layer electrodes are formed on the first layer electrodes, thereby achieving electrical connection. Further, the first layer electrodes are formed of transparent electrodes with low resistance or of a metal thin film made of aluminum or the like, whereby narrow electrodes with low resistance are provided, which enables a smaller parasitic capacitance. Moreover, there is adopted planar arrangement, in which the first layer electrodes do not overlap the second layer electrodes, except the regions in which the first layer electrodes overlap the second layer electrodes in two layers, which realizes low power consumption and high image quality display.

### BRIEF DESCRIPTION OF THE DRAWINGS

In the accompanying drawings:

FIG. 1 is a schematic diagram in which a substrate that constitutes a semi-transmission type liquid crystal display device of the present invention is seen from the top;

FIGS. 2A and 2B are schematic diagrams each showing a section of the semi-transmission type liquid crystal display device of the present invention;

FIG. 3 is a schematic diagram in which a substrate that constitutes a transmission type liquid crystal display device of the present invention is seen from the top;

FIGS. 4A and 4B are schematic diagrams each showing a section of the transmission type liquid crystal display device of the present invention;

FIG. 5 is a sectional view of a conventional semi-transmission type liquid crystal panel;

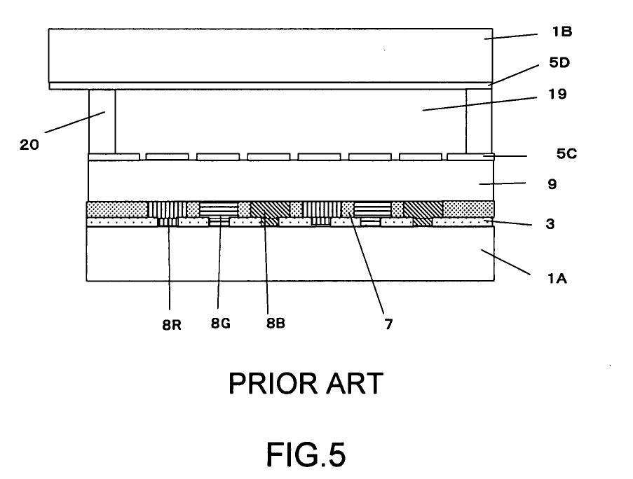

FIG. 6 is a sectional view of a semi-transmission type liquid crystal panel of the present invention; and

FIG. 7 is a top view of a substrate for a transmission type liquid crystal display device of the present invention.

### DESCRIPTION OF THE PREFERRED EMBODIMENTS

The liquid crystal display device according to the present invention comprises a first substrate having plural signal electrodes, a second substrate having plural scanning electrodes, and a liquid crystal layer between the first substrate and the second substrate. Pixels are respectively formed at intersecting portions of the plural signal electrodes and the plural scanning electrodes. In the device, the plural signal electrodes are divided into a first signal electrode group and a second signal electrode group to perform divided-screen drive. Wiring electrodes for supplying the drive signals to the second signal electrode group are formed on the first substrate. An insulating layer is formed on portions except connecting regions on the wiring electrodes. And then, the wiring electrodes are electrically connected with the signal electrodes of the second signal electrode group, in the connecting regions in which the insulating layer is not formed. Here, the plural connecting regions may be provided to each of the signal electrodes that constitute the second signal electrode group. Further, the device is structured in such a manner that the insulating layer has a thickness larger than that of a conductive layer which constitutes the signal electrode groups. Alternatively, the device may be structured in such a manner that the insulating layer has a thickness larger than the total thickness of the conductive layer, which constitutes the signal electrode groups, and the wiring electrodes. Here, it is desirable that the wiring electrodes be not formed immediately below the signal electrodes which constitute the first signal electrode group.

Further, the device may be structured in such that, the wiring electrodes are formed of a reflecting material, and reflecting portions may be formed of the reflecting material at portions on the first substrate which correspond to the pixels. Accordingly, there can be realized a semi-transmission type or reflection type liquid crystal display device.

Moreover, a colored insulating film may be used as the insulating film.

Furthermore, a method of manufacturing a liquid crystal display device according to the present invention includes a step of forming wiring electrodes formed of a conductive thin film on a first substrate, a step of forming an insulating film on the wiring electrodes except portions to be connecting regions, a step of forming a transparent conductive film on the first substrate to provide the transparent conductive film directly on the wiring electrodes in the connecting regions, and a step of etching the transparent conductive film to form a first signal electrode group and a second signal electrode group. In the etching step, the signal electrodes of the second signal electrode group are electrically connected with the wiring electrodes through the connecting regions. In addition, a reflecting material is used for the conductive thin film, and in the step of forming wiring electrodes, reflecting electrodes, which are not electrically connected with the wiring electrodes, are formed.

Hereinafter, detailed description will be made of a liquid crystal display device according to the present invention based on embodiments.

### Embodiment 1

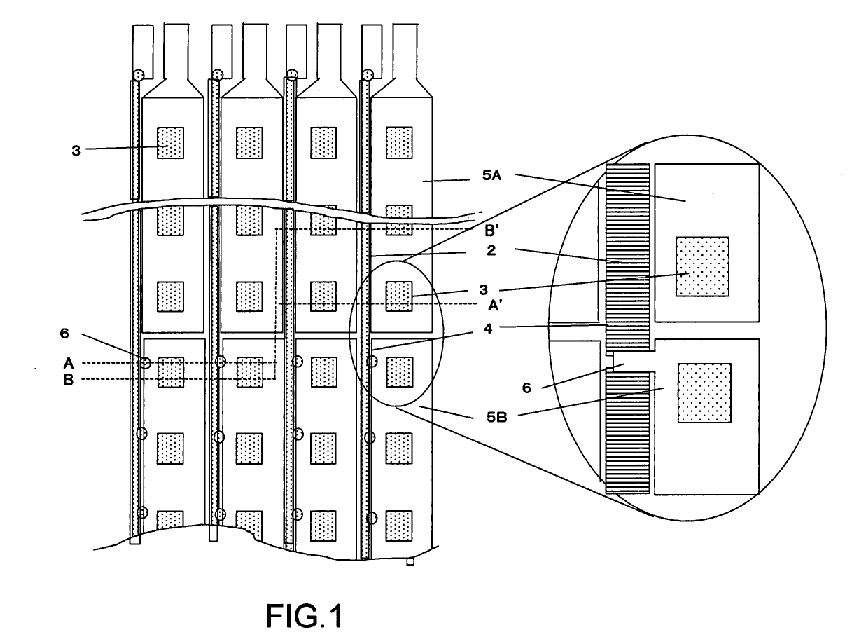

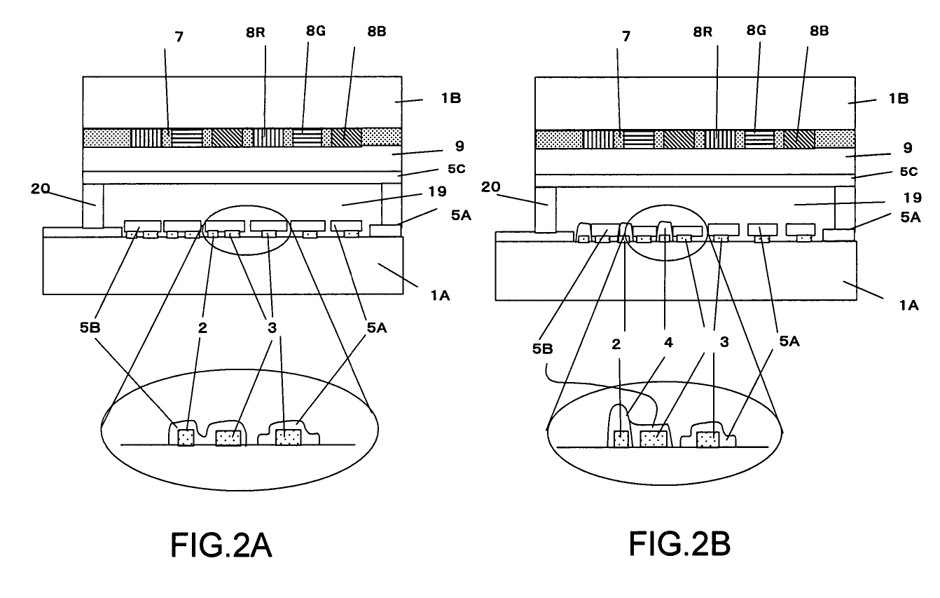

Description will be made of a semi-transmission type liquid crystal display device in this embodiment with reference to FIG. 1 and FIGS. 2A and 2B. FIG. 1 is a schematic diagram in which a substrate that constitutes the semi-transmission type liquid crystal display device is seen from the top. FIGS. 2A and 2B are sectional views each showing the semi-transmission type liquid crystal display device. FIG. 2A shows the section taken along a line A-A′, and FIG. 2B shows the section taken along a line B-B′. As shown in FIGS. 2A and 2B, liquid crystal 19 is injected between a substrate 1B having color filters formed thereon and an opposing substrate 1A having signal electrodes formed thereon by using a sealing member 20. Formed on the substrate 1B are scanning electrodes for applying a voltage to the liquid crystal. The present invention is characteristic in the structure of each of the signal electrodes formed on the opposing substrate 1A. Explanation will be made of the case where a glass substrate is used as the opposing substrate 1A. A metal thin film having high conductivity is formed on the glass substrate by sputtering or the like, and then, wiring electrodes 2 and reflecting portions 3 are simultaneously formed by patterning such as photolithography. At this point, the wiring electrodes 2 and the reflecting portions 3 are electrically separated from each other, and thus, a parasitic capacitance is not generated between each of the wiring electrodes 2 and each of the reflecting portions 3. Next, acrylic photo-sensitive resin having insulating property is applied thereon by spinning or the like, and the applied resin is subjected to patterning by photolithography, thereby forming an insulating film 4. At this point, as shown in FIG. 1 and FIGS. 2A and 2B, there exist regions 6 without the insulating film while the insulating film 4 is formed on the wiring electrodes. The shape of each of the regions 6, in which the insulating film is not provided, is arbitrary, but it is preferable that the size does not overlap a pixel. Thereafter, a transparent conductive film is formed by sputtering or the like, and the film is subjected to patterning, thereby forming signal electrodes 5A and 5B for liquid crystal drive. Accordingly, there is completed a semi-transmission type opposing substrate. Here, the signal electrodes 5A are input with drive signals from the outside without the use of the wiring electrodes 2, and the signal electrodes 5B are input with drive signals from the outside through the wiring electrodes 2. A first pixel group constituted of the plural signal electrodes 5A and scanning electrodes and a second pixel group constituted of the plural signal electrodes 5B and scanning electrodes can be driven with the same scanning signal. Thus, pixels can be driven with the divisions the number of which is half of the number in a conventional case. Further, each of the wiring electrodes is preferably provided at a portion corresponding to the portion between the signal electrodes 5A in order that a parasitic capacitance may not be generated between the wiring electrode 2 and the signal electrode 5A to which the drive signal is applied not through the wiring electrode 2. In order to supply the drive signal to the signal electrode 5B through the wiring electrode 2, there needs to be provided the above-described region 6, in which the insulating film is not provided, between the wiring electrode 2 and an electrode terminal for a display panel. This enables the signal from an external driver to enter the wiring electrode 2 through the electrode terminal to be supplied to the signal electrode 5B.

Further, formed on the other substrate 1B are a black matrix 7 and color filters 8R, 8G, and 8B, which are of pigment-dispersion type, by patterning with the use of a photo-sensitive color resist in a general manner. Then, thermo-setting or photo-sensitive transparent resin is applied thereon with a spinner or the like to be hardened. Moreover, a transparent conductive film is formed by sputtering or the like, and the film is subjected to patterning by photolithography or the like, thereby forming scanning electrodes 5C for liquid crystal drive. The two of the opposing substrate 1A and the substrate 1B are allowed to adhere to each other by means of the sealing member 20, and a resultant space is injected with the liquid crystal 19. Therefore, the liquid crystal display device is manufactured.

It is sufficient that the thickness of the metal thin film formed on the opposing substrate 1A be at the level that enables low-resistance wiring; however, the thickness is preferably about 0.10 μm to 0.30 μm in consideration of processability and economy. In this embodiment, the metal thin film is also used for the reflecting portions, and thus, needs to have reflecting property as well as low resistance. Further, the thickness of the insulating film 4, which is formed on the wiring electrode 2 made of the metal thin film, is preferably 0.2 μm to 2.0 μm. This is because an excess thickness makes patterning processing difficult although the more thickness is preferable for lower power consumption.

As described above, the separation of the signal electrodes can be realized by only adding the application step of the photo-sensitive resin having insulating property and the patterning step of the applied resin to a general processing step of an opposing substrate. Therefore, drive can be performed with the smaller duty number than that in the conventional case with respect to the same pixel structure. On the color filter substrate side, there is sufficiently used a so-called transmission type color filter in which patterns for a black matrix, red, green, and blue are simply formed by photolithography. A reflecting film necessary for semi-transmission type does not need to be provided on the color filter substrate.

In this embodiment, aluminum or an aluminum alloy may be used for the metal thin film. The thickness is set to 0.15 μm. Further, the thickness of the transparent insulating film 4 is set to 0.5 μm. Alternatively, silver or a silver alloy may be used for the metal thin film. In this case, the thickness is set to 0.12 μm. Chrome may also be used. On the color filter substrate side, there is used the so-called transmission type color filter in which patterns for a black matrix, red, green, and blue are simply formed by photolithography.

By enlarging the area of each of the reflecting portions in the above-described structure, there can be substantially obtained a reflection type liquid crystal display device.

### Embodiment 2

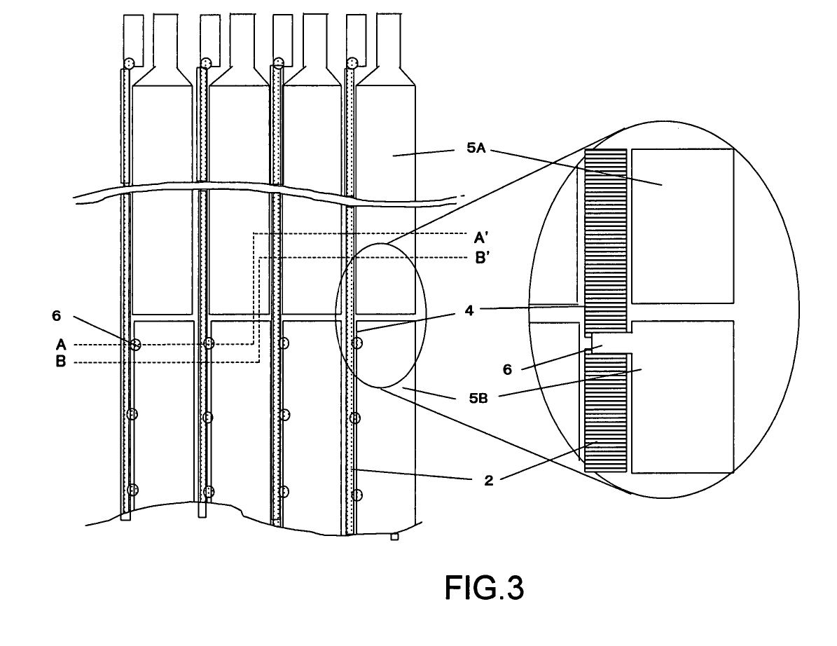

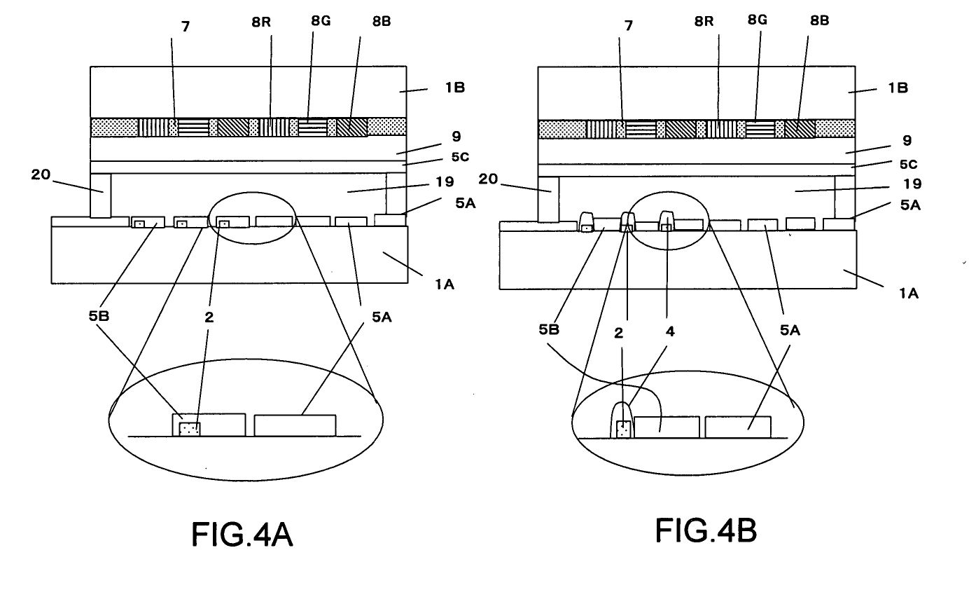

Description will be made of a transmission type liquid crystal display device in this embodiment with reference to FIG. 3 and FIGS. 4A and 4B. FIG. 3 is a schematic diagram in which a substrate that constitutes the transmission type liquid crystal display device in this embodiment is seen from the top. FIGS. 4A and 4B are sectional views each showing the transmission type liquid crystal display device. FIGS. 4A and 4B correspond to the sections taken along by an A-A′ line and B-B′ line, respectively. As shown in FIGS. 4A and 4B, the liquid crystal 19 is injected between the substrate 1B on which the color filters are formed and the opposing substrate 1A on which the signal electrodes are formed by using the sealing member 20. Formed on the substrate 1B are the scanning electrodes 5C for applying a voltage to the liquid crystal. This embodiment relates to a transmission type display device, and thus, the reflecting portions formed in Embodiment 1 are not provided. This embodiment has the same structure as that in Embodiment 1 except this point. Therefore, the overlapping explanation will be properly omitted. As in Embodiment 1, a glass substrate is used as the opposing substrate 1A on which the signal electrodes are formed. A metal thin film, which is made of silver, a silver alloy, or the like, is formed on the glass substrate by sputtering. The film is subjected to patterning to form the wiring electrodes 2. In this embodiment, the thickness of the film made of silver or a silver alloy is set to 0.12 μm. In this embodiment, the metal thin film is used for the wiring electrodes, and thus, does not need to have reflecting property as in Embodiment 1. It is sufficient that the film be made of the material having low resistance that enables drive at the time of application of a signal to an electrode. Next, acrylic transparent photo-sensitive resin is applied onto the wiring electrodes 2 with a spinner, and the applied resin is subjected to patterning, thereby forming the transparent insulating film 4. At this point, as shown in FIG. 3 and FIGS. 4A and 4B, while the insulating film 4 is formed on the wiring electrodes, there exist the regions 6 in which the insulating film is not formed. Thereafter, the transparent conductive film made of ITO or the like is formed by sputtering, and the film is subjected to patterning, thereby forming the signal electrodes 5A and 5B for liquid crystal drive.

Formed on the other substrate are the black matrix 7 and color filters 8R, 8G, and 8B which are of pigment-dispersion type by patterning with the use of a color photo-sensitive resist in which acrylic transparent resin is mixed with a pigment. Then, thermo-setting transparent resin is applied thereon with a spinner to be hardened. Moreover, the transparent conductive film is formed by sputtering, and the film is subjected to patterning, thereby forming the scanning electrodes 5C for liquid crystal drive. The two of the opposing substrate 1A and the substrate 1B are allowed to adhere to each other by means of the sealing member 20, and a resultant space is injected with the liquid crystal 19. Therefore, the liquid crystal display device is manufactured.

### Embodiment 3

In this embodiment, description will be made of a structure in which a color filter material is used for the insulating film 4. The explanations overlapping with those in the above-described embodiments will be omitted properly. The glass substrate is used for the opposing substrate on which the signal electrodes are formed. The transparent conductive film is formed thereon by sputtering, and then, the film is subjected to patterning, thereby forming the wiring electrodes. In this embodiment, the thickness of the transparent conductive film is set to 0.20 μm. A red-color filter, which consists of a color filter material, is applied thereon with a spinner, and the applied film is subjected to patterning to thereby form the insulating film 4. The color filter material is not limited to the red-color filter, and may be a green or blue-color filter or a light shielding black matrix. In the case of the black matrix, since carbon is contained in the pigment, there is preferably used, for the insulating film, insulating resin of coating carbon type which has increased insulating property. At this point, although the insulating film 4 is formed on the wiring electrodes, there also exist the regions 6 in which the insulating film is not formed. Thereafter, the transparent conductive film made of ITO or the like is formed by sputtering, and then, is subjected to patterning, thereby forming the signal electrodes for liquid crystal drive.

As in Embodiment 1, formed on the other substrate are the black matrix and the color filters, which are of pigment-dispersion type, by patterning with the use of a color photo-sensitive resist in which acrylic transparent resin is mixed with a pigment. Then, thermo-setting transparent resin is applied thereon with a spinner to be hardened. Moreover, the transparent conductive film is formed by sputtering, and the film is subjected to patterning, thereby forming the scanning electrodes for liquid crystal drive. The above pair of substrates are allowed to adhere to each other by means of the sealing member 20, and a resultant space is injected with the liquid crystal 19. Accordingly, the liquid crystal display device is manufactured.

### Embodiment 4

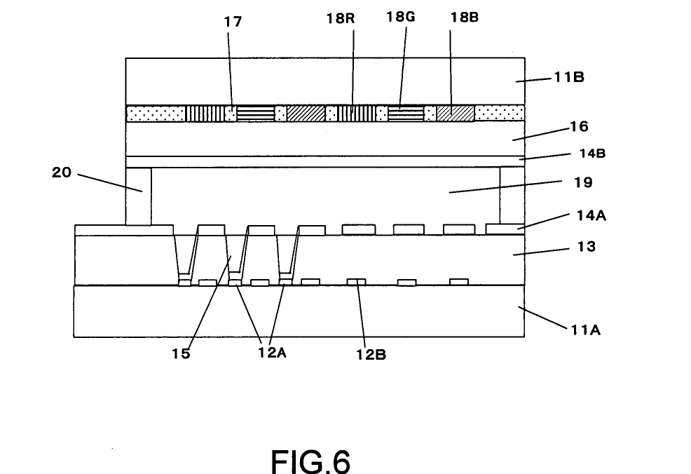

Description will be made of a liquid crystal display device according to the present invention with reference to the accompanying drawings. FIG. 6 is a sectional view of a semi-transmission type liquid crystal panel in this embodiment. A top view of a substrate that constitutes the semi-transmission type liquid crystal panel is the same as that of FIG. 1. First, explanation will be made of an opposing substrate on which signal electrodes are formed. A metal thin film having high conductivity is formed on a glass substrate 11A by sputtering or the like, and the film is subjected to patterning by photolithography or the like, thereby simultaneously forming wiring electrodes 12A and reflecting electrodes 12B. That is, the metal thin film is left in at least a part of a pixel portion at the time of patterning of the metal thin film, whereby the reflecting electrodes 12B are formed. The reflecting electrodes 12B and the wiring electrodes 12A are structured so as to be electrically separated from each other and not to have a parasitic capacitance with respect to the signal electrodes. Acrylic transparent photo-sensitive resin is applied onto the substrate by spinning or the like to form a transparent insulating film 13. Next, the transparent insulating film 13 is formed with holes 15 by patterning. The holes 15 each are arbitrary in shape, but preferably have a size that does not overlap a pixel. Thereafter, a transparent conductive film made of ITO or the like is formed by sputtering, and the film is subjected to patterning, thereby forming signal electrodes 14A for liquid crystal drive.

Further, formed on another substrate 11B are a black matrix 17 and color filters 18R, 18G, and 18B, which are of pigment-dispersion type, by patterning with the use of a color photo-sensitive resist in which acrylic transparent resin is mixed with a pigment. Then, thermo-setting transparent resin 16 is applied thereon with a spinner or the like to be hardened. Moreover, a transparent conductive film is formed by sputtering, and the film is subjected to patterning, thereby forming scanning electrodes 14B for liquid crystal drive. The above pair of substrates are allowed to adhere to each other by means of the sealing member 20, and a resultant space is injected with the liquid crystal 19. Accordingly, the liquid crystal display device is manufactured.

Here, it is sufficient that the thickness of the metal thin film be at the level that enables low-resistance wiring; however, the thickness is preferably about 0.10 μm to 0.30 μm in consideration of processability and economy. The thickness of the transparent insulating film is preferably 0.5 μm to 4.0 μm because an excess thickness makes drilling processing difficult although the more thickness is preferable for lower power consumption.

As described above, the separation of the signal electrodes can be realized by only adding the application step of the transparent photo-sensitive resin and the drilling step of the applied resin to a general processing step of an opposing substrate. Therefore, drive can be performed with the smaller duty number than that in the conventional case with respect to the same pixel structure. On the color filter substrate side, it is sufficient that there be used a so-called transmission type color filter in which patterns for a black matrix, red, green, and blue are simply formed by photolithography. On the color filter substrate side, a step of forming a reflecting film can be omitted. Further, the wiring electrodes 12A are arranged among a first signal electrode group for lower power consumption; however, the wiring electrodes 12 may be arranged immediately below the first signal electrode group if the wiring electrodes are sufficiently narrow and if the thickness of the transparent insulating film 13 is sufficiently thick.

In this embodiment, aluminum or an aluminum alloy is used for the metal thin film, and the thickness is set to 0.15 μm. Further, the thickness of the transparent insulating film 13 is set to 1.0 μm. On the color filter substrate side, there is used the so-called transmission type color filter in which patterns for a black matrix, red, green, and blue are simply formed by photolithography.

### Embodiment 5

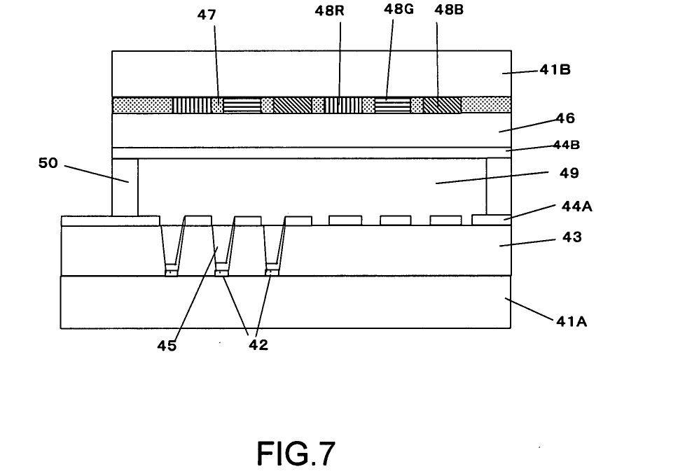

FIG. 7 is a sectional view of a semi-transmission type liquid crystal panel in this embodiment. A top view of a substrate that constitutes the semi-transmission type liquid crystal panel is the same as that of FIG. 1. First, silver or a silver alloy is deposited onto a glass substrate 41A by sputtering, and the film is subjected to patterning to form wiring electrodes 42B. Then, there is provided an opposing substrate on which signal electrodes are provided. Here, the thickness of the film made of silver or a silver alloy is set to 0.12 μm. Acrylic transparent photo-sensitive resin is applied thereon with a spinner to form a transparent insulating film 43. Next, the transparent insulating film is formed with holes 45 by patterning. Thereafter, ITO or the like is deposited by sputtering, and the deposited film is subjected to patterning, thereby forming signal electrodes 44A for liquid crystal drive.

Further, formed on another substrate 41B are a black matrix 47 and color filters 48R, 48G, and 48B, which are of pigment-dispersion type, by patterning with the use of a color photo-sensitive resist in which acrylic transparent resin is mixed with a pigment. Then, thermo-setting transparent resin 46 is applied thereon with a spinner to be hardened. Moreover, a transparent conductive film is formed by sputtering, and the film is subjected to patterning, thereby forming scanning electrodes 44B for liquid crystal drive. The above pair of substrates 41A and 41B are allowed to adhere to each other by means of a sealing member 50, and a resultant space is injected with liquid crystal 49. Accordingly, the liquid crystal display device is manufactured.

According to the present invention, the parasitic capacitance is not generated since the laminated electrodes are not positioned in a vertical relationship, which enables lower power consumption. At the same time, there can be realized the liquid crystal display device with the better display quality such as contrast or viewing angle and the lower power consumption than those of the conventional liquid crystal display device with a one-layer electrode structure. Further, the formation step of a reflecting film on the color filter substrate side is omitted, and the step equivalent to the formation step is added to the manufacturing step of an opposing substrate. Thus, there is enabled the wiring that attains the separation of the column electrodes, which can realize the drive with the smaller number of duty.

By adopting the structure of the present invention to the simple matrix type liquid crystal display device, the drive can be performed with the number of divisions smaller than that in the conventional case even with a large quantity of information (the number of pixels). Thus, the contrast and viewing angle are improved, which enables lower power consumption. Accordingly, the present invention can be applied to color liquid crystal display devices such as a portable information device, personal computer, and monitor, and the liquid crystal display device of the present invention can replace a TFT-LCD.

1. A liquid crystal display device which comprises: a first substrate on which plural signal electrodes are formed; a second substrate on which plural scanning electrodes are formed; and a liquid crystal layer provided between the first substrate and the second substrate and in which pixels are respectively formed at intersecting portions of the plural signal electrodes and the plural scanning electrodes, wherein the plural signal electrodes are divided into a first signal electrode group and a second signal electrode group to perform divided-screen drive, wiring electrodes which supply drive signals to the second signal electrode group, are formed on the first substrate, an insulating layer is formed on portions except connecting regions on the wiring electrodes, and the wiring electrodes are electrically connected with the signal electrodes, which constitute the second signal electrode group, in the connecting regions in which the insulating layer is not formed.

2. A liquid crystal display device according to claim 1, wherein the plural connecting regions are provided to each of the signal electrodes that constitute the second signal electrode group.

3. A liquid crystal display device according to claim 1, wherein the insulating layer has a thickness larger than that of a conductive layer which constitutes the signal electrode groups.

4. A liquid crystal display device according to claim 3, wherein the insulating layer has a thickness larger than a total thickness of the conductive layer, which constitutes the signal electrode groups, and the wiring electrodes.

5. A liquid crystal display device according to claim 1, wherein the wiring electrodes are formed at portions except portions immediately below the signal electrodes which constitute the first signal electrode group.

6. A liquid crystal display device according to claim 1, wherein the wiring electrodes are formed of a material having reflecting property, and reflecting portions, which are formed of the material having reflecting property, are provided at portions on the first substrate which correspond to the pixels.

7. A liquid crystal display device according to claim 1, wherein the insulating film comprises a colored insulating film.

8. A method of manufacturing a liquid crystal display device, comprising the steps of:
forming wiring electrodes formed of a conductive thin film on a first substrate;
forming an insulating film on the wiring electrodes except portions to be connecting regions;
forming a transparent conductive film on the first substrate to provide the transparent conductive film directly on the wiring electrodes in the connecting regions; and
etching the transparent conductive film to form a first signal electrode group and a second signal electrode group, wherein, in the etching step, the signal electrodes, which constitute the second signal electrode group, are electrically connected with the wiring electrodes through the connecting regions.

9. A method of manufacturing a liquid crystal display device according to claim 8, wherein:
a material having reflecting property is used for the conductive thin film; and
in the step of forming wiring electrodes, reflecting electrodes, which are not electrically connected with the wiring electrodes, are formed.
